(19) United States
(12) Patent Application Publication
(10) Pub. No.: US 2008/0004159 A1
(43) Pub. Date: Jan. 3, 2008

(54) Driving force control apparatus and control method for a vehicle

(75) Inventors: Hideki Kubonoya, Toyota-shi (JP); Masaharu Tanaka, Toyota-shi (JP); Masami Kondo, Toyota-shi (JP); Seiji Kuwahara, Toyota-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: TOYOTA JIDOSHA KABUSHIKI KAISHA

(21) Appl. No.: 11/822,129

(22) Filed: Jul. 2, 2007

(30) Foreign Application Priority Data
Jul. 3, 2006 (JP) 2006-183905

(51) Int. Cl. B60W 10/04

(52) U.S. Cl. 477/115

(57) ABSTRACT

When determining whether to perform one shift, from among a downshift and an upshift to an adjacent gear speed from a predetermined gear speed after the other shift from among a downshift and an upshift was performed, a shift line switching portion switches a shift line from a shift line that is based on the speed ratio of the predetermined gear speed to a shift line that is based on the speed ratio after the one shift. Accordingly, a shift determining portion determines whether to perform the one shift using the shift line that is based on the speed ratio after the one shift, and that shift is executed.

### INCORPORATION BY REFERENCE

The disclosure of Japanese Patent Application No. 2006-183905 filed on Jul. 3, 2006, including the specification, drawings and abstract is incorporated herein by reference in its entirety.

### BACKGROUND OF THE INVENTION

1. Field of the Invention

The invention relates to a driving force control apparatus and control method that realizes a target driving force in a vehicle having a stepped automatic transmission that is operatively linked to an engine. More particularly, the invention relates to shift control of the stepped automatic transmission.

2. Description of the Related Art

Japanese Patent Application Publication No. JP-A-2002-180860, for example, describes a vehicle having a driving force control apparatus for a vehicle which i) sets a target driving force, i.e., target axle torque, to be generated in the vehicle based on vehicle speed and an accelerator depression amount, i.e., the operation amount of an accelerator pedal, ii) sets a target speed (gear speed) suitable to obtain that target driving force based on the vehicle speed and engine speed and the like, and iii) controls an automatic transmission to establish that target gear speed when that target gear speed differs from the actual gear speed. In this kind of vehicle, a shift determination is normally made based on the vehicle speed and the throttle opening amount converted from engine torque, according to a shift map that has been stored in advance.

Vehicle engines are known to have a torque characteristic in which the output torque tops out or reaches maximum torque in the high load region, i.e., a characteristic in which the amount change in the output torque with respect to the amount of change in the throttle opening amount becomes extremely small when the throttle opening amount is large. As described above, when the shift determination is made with the engine torque converted to a throttle opening amount, the throttle opening amount changes greatly with the slightest change in engine torque. As a result, shift hunting may occur in which an upshift determination and a downshift determination are made in a short period of time.

To prevent this, it is possible to use the driving force of the vehicle instead of the throttle opening amount as a parameter for the shift determination in view of comprehensive control that coordinates a brake control system for stabilizing vehicle behavior during take-off, braking, and turning, for example, with a driving support system such as cruise control. However, when a conventional shift map having the throttle opening amount and vehicle speed as parameters is converted to a shift map having only the driving force as a parameter, a region appears in which an upshift line of a predetermined gear speed and a downshift line of a gear speed on the higher speed side next to that gear speed overlap. As a result, shift hunting may occur in this region.

### SUMMARY OF THE INVENTION

This invention thus provides a driving force control apparatus and control method for a vehicle to prevent shift hunting even if the driving force of the vehicle is used as a parameter for the shift determination.

A first aspect of the invention relates to a driving force control apparatus for a vehicle having an engine and a stepped automatic transmission that is operatively linked to the engine. The driving force control apparatus includes a target driving force setting portion that sets a target driving force of the vehicle; a shift determining portion that determines a gear speed into which the stepped automatic transmission is shifted based on at least vehicle driving force determined using a pre-stored shift map (also called a shift line graph or shift diagram) having hysteresis between an upshift line and a downshift line of a predetermined gear speed of the stepped automatic transmission; and a shift line switching portion which, in order to determine whether to perform one shift, from among a downshift and an upshift to an adjacent gear speed from the predetermined gear speed after the other shift from among a downshift and an upshift was performed, switches from a shift line based on the speed ratio of the predetermined gear speed to a shift line based on the speed ratio after the one shift.

According to this structure, when determining whether to perform one shift, from among a downshift and an upshift from the predetermined gear speed after the other shift from among a downshift and an upshift was performed, the shift line switching portion switches the shift line from the shift line based on the speed ratio of the predetermined gear speed to the shift line that is based on the speed ratio after the one shift. Accordingly, the shift determining portion determines whether to perform the one shift using the shift line that is based on the speed ratio after the one shift, and then downshifts or upshifts accordingly. Therefore, the region in the shift map in which the upshift line of the predetermined gear speed and the downshift line of the next higher gear speed is eliminated so shift hunting is prevented.

Also, the driving force control apparatus may also include a driving force minute change determining portion that determines whether the driving force of the vehicle is minutely changing within a predetermined range. When the driving force minute change determining portion determines that the driving force of the vehicle is minutely changing, the shift line switching portion may switch the shift line from the shift line that is based on the speed ratio of the predetermined gear speed to the shift line that is based on the speed ratio after the one shift. According to this structure, when the driving force of the vehicle minutely changes within the predetermined range, such as while cruise control is being operated, the shift line switching portion switches the shift line from the shift line that is based on the speed ratio of the predetermined gear speed to the shift line that is based on the speed ratio after the one shift. As a result, shift hunting which tends to occur when the driving force minutely changes can be prevented.

Further, the driving force control apparatus may also include a region determining portion that determines whether the driving force of the vehicle is within a region that crosses the shift line based on the speed ratio after the one shift to which the shift line switching portion switched. When the region determining portion determines that the driving force of the vehicle is within the region that crosses the shift line based on the speed ratio after the one shift, the shift line switching portion may switch back to the shift line from the shift line that is based on the speed ratio after the one shift to the shift line that is based on the speed ratio of the predetermined gear speed. According to this structure, when the driving force of the vehicle enters the region where shift hunting will not occur even if hysteresis is not ensured, the shift line is returned to its original position so driving force for the vehicle can be ensured.

Also, the driving force control apparatus may further include an elapsed time calculating portion that counts the elapsed time after the other shift, from among the downshift and the upshift is performed; a difference calculating portion that calculates the difference between the driving force of the vehicle and the shift line used to determine the other shift; a shift prohibited time determining portion that determines a shift prohibited time during which a shift is prohibited, based on the difference calculated by the difference calculating portion from a pre-stored relationship; and a shift prohibiting portion that prohibits the one shift, from among the downshift and the upshift until after the shift prohibited time has elapsed. According to this structure, in particular, when the vehicle is traveling at high speed, shift hunting due to a slight fluctuation in driving force is prevented in the region in which the downshift line for a predetermined gear speed based on the speed ratio of the predetermined gear speed and the upshift line from the predetermined gear speed become close together so that hysteresis is extremely small, as well as in the region in which the downshift line into the next adjacent gear speed, which is based on the speed ratio of the next adjacent gear speed, and the upshift line from the next adjacent gear speed become close together so that hysteresis is extremely small.

The shift map may also include an upshift line and a downshift line set for each gear speed in a two-dimensional coordinate system having a driving force axis, which has driving force generated in each gear speed of the automatic transmission as a parameter, and a vehicle speed axis, which has the speed of the vehicle as a parameter. Therefore, the shift determination may also be made based on the vehicle speed and the driving force of the vehicle in each gear speed.

Also, the driving force control apparatus may further include a control system that automatically controls the driving force of the vehicle irrespective of the amount of output required by a driver. The target driving force setting portion may set the target driving force of the vehicle by adjusting the required driving force that is required by the control system, and when driving force is required by the control system, the shift line switching portion may switch from the shift line that is based on the speed ratio of the predetermined gear speed to the shift line that is based on the speed ratio after the one shift. According to this structure, shift control is executed based on the shift line that was switched based on the required driving force that is required by the control system that automatically controls the driving force of the vehicle, such as cruise control. Therefore, when the driving force of the vehicle minutely changes within the predetermined range, such as while cruise control is being operated, the shift line switching portion switches from the shift line that is based on the speed ratio of the predetermined gear speed to the shift line that is based on the speed ratio after the one shift. As a result, shift hunting, which tends to occur when the driving force minutely changes, is prevented.

Further, not only the driving force that is actually generated but also a driving force related value, such as the amount of driving force required of the vehicle by the driver, i.e., required driving force or required driving torque, which corresponds to an operation amount of an output operating member that is operated by the driver may also be used to determine the driving force of the vehicle.

Also, an internal combustion engine such as a gasoline engine or a diesel engine may be used as the engine that serves as the source of driving force. Moreover, an electric motor or the like may also be used in addition to this engine, as a source of driving force to assist with running. When an electric motor is used as a source of driving force in this way, a target throttle valve opening amount and a target driving current from a power storing device, for example, for driving the electric motor, and the like are calculated to realize the target driving force by the engine output and the electric motor output.

Also, the stepped automatic transmission may include i) any one of various planetary gear type multi-speed transmissions of four, five, six, seven, or eight forward gear speeds, for example, or a synchronous mesh-type parallel twin-shaft automatic transmission, for example. The planetary gear type multi-speed transmissions are structured such that a predetermined gear speed, from among a plurality of gear speeds, is selectively established by selectively connecting rotating elements of a plurality of planetary gear sets together with friction engagement devices. The synchronous mesh-type parallel twin-shaft automatic transmission is provided with a plurality of sets of speed gears that are in constant mesh on two shafts. Gear speeds are automatically switched by placing the automatic transmission in a selected power transmitting state by a synchronizer in which one of the plurality of sets of speed gears is driven by a hydraulic actuator or the like. Also, the stepped automatic transmission is not limited as long as the speed ratios can effectively be changed in a step like manner, so it may also be a continuously variable transmission used to change the speed ratio in a step like manner for each preset speed ratio.

Further, not only the speed of the vehicle but also a vehicle speed related value that essentially corresponds to the vehicle speed, such as the rotation speed of the output shaft of the transmission or the rotation speed of the wheels, which directly corresponds to the vehicle speed, may also be used as the vehicle speed.

Also, the stepped automatic transmission may be transverse mounted in a vehicle such as a FF (front engine, front drive) vehicle in which the axis of the automatic transmission lies in the width direction of the vehicle, or longitudinal mounted in a vehicle such as a FR (front engine, rear drive) vehicle in which the axis of the automatic transmission lies in the longitudinal direction of the vehicle.

Further, the engine and the stepped automatic transmission need only be operatively linked. Therefore, a damper, a lockup clutch, a lockup clutch with a damper, or a fluid power transmitting device or the like may be interposed between the crankshaft of the engine and the input shaft of the stepped automatic transmission. Also, a torque converter or fluid coupling or the like may also be used as this fluid power transmitting device.

Also, a second aspect of the invention relates to a driving force control method for a vehicle having an engine and a stepped automatic transmission that is operatively linked to the engine. This driving force control method includes a) setting a target driving force of the vehicle; b) determining a speed into which the stepped automatic transmission is to be shifted based on at least vehicle driving force from a pre-stored shift map having hysteresis between an upshift line and a downshift line of a predetermined gear speed of the stepped automatic transmission; and c) switching, in order to determine whether to perform one shift, from among a downshift and an upshift from the predetermined gear speed to an adjacent gear speed after the other shift was performed from among a downshift and an upshift, a shift line from a shift line that is based on a speed ratio of the predetermined gear speed to a shift line that is based on the speed ratio after the one shift.

Also, the driving force control method may further include d) determining whether the driving force of the vehicle is minutely changing within a predetermined range. When it is determined by step d) that the driving force of the vehicle is minutely changing, step c) may switch the shift line from the shift line that is based on the speed ratio of the predetermined gear speed to the shift line that is based on the speed ratio after the one shift.

Further, the driving force control method may also include e) determining whether the driving force of the vehicle is within a region that crosses the shift line that is based on the speed ratio after the one shift and to which the shift line was switched by step c). When it is determined by step e) that the driving force of the vehicle is within the region that crosses the shift line that is based on the speed ratio after the one shift, step c) may return the shift line from the shift line that is based on the speed ratio after the one shift to the shift line that is based on the speed ratio of the predetermined gear speed.

Also, the driving force control method may further include f) counting the elapsed time after the other shift, from among the downshift and the upshift, was performed; g) calculating a difference between the driving force of the vehicle and the shift line used to determine the other shift; h) determining a shift prohibited time during which a shift is prohibited, based on the difference calculated by step g) from a pre-stored relationship; and i) prohibiting the one shift, from among the downshift and the upshift, from being performed until the elapsed time exceeds the shift prohibited time.

Moreover, in the foregoing driving force control method, the shift map may include an upshift line and a downshift line set for each speed in a two-dimensional coordinate system having a driving force axis which has driving force generated in each speed of the automatic transmission as a parameter, and a vehicle speed axis which has the speed of the vehicle as a parameter.

Also, the driving force control method may further include j) automatically controlling the driving force of the vehicle irrespective of an amount of output required by a driver. Step a) may set the target driving force of the vehicle by adjusting a required driving force that is required by step j), and when driving force is required by step j), step c) may switch the shift line from the shift line that is based on the speed ratio of the predetermined gear speed to the shift line that is based on the speed ratio after the one shift.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a block line diagram schematically showing both the structure of a power transmitting apparatus according to a first example embodiment of the invention, and the main portions of a control system provided in a vehicle for controlling that power transmitting apparatus and the like;

FIG. 2 is a functional block line diagram schematically showing the main portions of the control functions according to an electronic control apparatus shown in FIG. 1;

FIG. 3 is a functional block line diagram showing both the main portions of the control functions according to the electronic control apparatus shown in FIG. 1, and the main portions of the functions of a driver model portion and a powertrain manager portion shown in FIG. 2;

FIG. 4 is a graph showing an example of a pre-stored relationship used by a required engine torque calculating portion shown in FIG. 3 to obtain a required engine torque;

FIG. 5 is a shift map used by a first shift determining portion shown in FIG. 3 to make a shift determination;

FIG. 6 is a shift map used by a second shift determining portion shown in FIG. 3 to make a shift determination;

FIG. 7 is a functional block line diagram illustrating in detail the functions related to the second shift determining portion which are not shown in FIG. 3;

FIG. 8 is a flowchart of a control routine for determining an upshift, which illustrates the main portions of control operations of the electronic control apparatus shown in FIG. 1;

FIG. 9 is a flowchart of a control routine for determining a downshift, which illustrates the main portions of control operations of the electronic control apparatus shown in FIG. 1;

FIG. 10 is a flowchart of a control routine that prohibits an upshift immediately after a downshift, which illustrates the main portions of control operations of the electronic control apparatus shown in FIG. 1;

FIG. 11 is a view of the operating states shown in FIGS. 8 and 9 in a two-dimensional coordinate system that shows the gear speed and driving force;

FIG. 12 is a graph showing a pre-stored relationship used to obtain the time for which a shift is prohibited in the operation in FIG. 10; and

FIG. 13 is a time chart illustrating the operation in FIG. 10.

### DETAILED DESCRIPTION OF THE PREFERRED EMBODIMENTS

In the following description and the accompanying drawings, the present invention will be described in more detail in terms of exemplary embodiments.

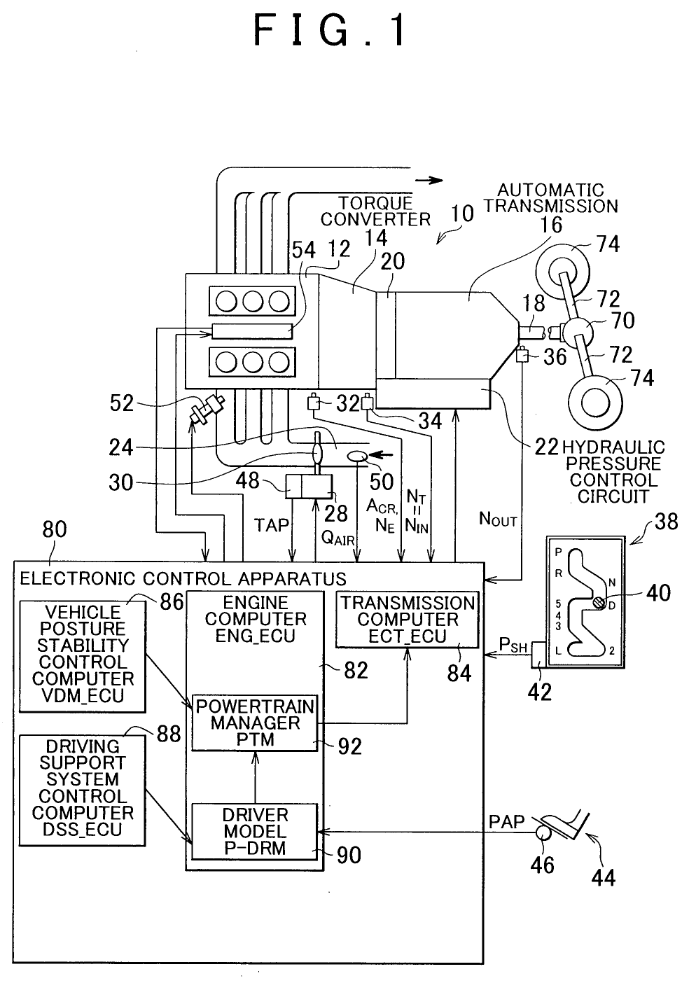

FIG. 1 is a block line diagram schematically showing both the structure of a power transmitting apparatus 10 for a vehicle to which the invention is applied, and the main portions of a control system provided in the vehicle for controlling that power transmitting apparatus 10 and the like. The power transmitting apparatus 10 includes a torque converter 14 and an automatic transmission 16 arranged in order on the same axis and housed in a transmission case which is a non-rotating member attached to the vehicle body. The automatic transmission 16 is operatively linked via the torque converter 14 to a crankshaft of an engine 12, which serves as a source of driving force for running the vehicle. Power generated by the engine 12 is input to the automatic transmission 16 via the torque converter 14 and transmitted to left and right driving wheels 74 from an output shaft 18 provided with the automatic transmission 16, via a differential gear unit (a final reduction gear) 70 and a pair of axles 72, which serve as drive shafts, and the like in that order.

The automatic transmission 16 is a planetary gear type automatic transmission that includes a plurality of hydraulic type friction engagement devices to selectively establish any one of a plurality of speeds (i.e., gear speeds). The automatic transmission 16 establishes a given speed by selectively engaging two of the hydraulic type friction engagement devices. The automatic transmission 16 then selectively switches speeds by selectively switching to the appropriate combination of engaged hydraulic type friction engagement devices. For example, the automatic transmission 16 can establish any one of six forward speeds, a reverse speed, and neutral, along with which a speed conversion corresponding to a speed ratio γ of the respective speed is established. These hydraulic type friction engagement devices of the automatic transmission 16 are all controlled by a hydraulic pressure control circuit 22 in which the line hydraulic pressure is the base pressure. This line hydraulic pressure is, for example, hydraulic pressure that has been regulated with hydraulic pressure generated by a mechanical oil pump 20 that is mechanically connected to and directly driven by the engine 12 as the base pressure, and is the maximum engagement pressure used to engage the hydraulic type friction engagement devices of the automatic transmission 16.

An electronic control apparatus 80 includes a so-called microcomputer that has a CPU, RAM, ROM, and an input/output interface, etc. The CPU processes signals according to a program stored in the ROM while using the temporary storage function of the RAM. For example, the electronic control apparatus 80 executes various controls such as output control of the engine 12 and shift control of the automatic transmission 16, and when necessary includes an engine computer 82 (hereinafter referred to as “ENG_ECU 82”), a transmission computer 84 (hereinafter referred to as “ECT_ECU 84”), a vehicle posture stability control computer 86 (hereinafter referred to as “VDM_ECU 86”), and a driving support system control computer 88 (hereinafter referred to as “DSS_ECU 88”) and the like.

Various signals are output to the electronic control apparatus 80 from various sensors and switches provided in the vehicle. These signals include a signal that indicates the detected crank angle speed, corresponding to a crank angle (position) A_{CR} (°) and engine speed N_{E} (rpm), output by the crank position sensor 32; a signal that indicates the detected turbine speed N_{T} (=input rotation speed N_{IN}) (rpm) of the torque converter 14, i.e., the input rotation speed N_{IN} (rpm) of the automatic transmission 16, output by the turbine speed sensor 34; a signal indicating the detected output shaft rotation speed N_{OUT} of the output shaft 18 corresponding to the vehicle speed related value output by the output shaft rotation speed sensor 36; a signal that indicates the detected shift operating position (P_{SH}) of a shift lever 40 output by the shift position sensor 42; a signal that indicates the detected accelerator depression amount PAP (%), which is the operation amount of an accelerator pedal 44, output by the accelerator depression amount sensor 46; a signal that indicates the detected throttle valve opening amount TAP (%), of an electronic throttle valve 30 provided in an intake pipe 24, output by the throttle position sensor 48; and a signal that indicates the detected intake air amount Q_{AIR} of the engine 12 output by the intake air amount sensor 50. The vehicle speed related value is a related value (corresponding value) that corresponds one to one to the vehicle speed V, i.e., the speed of the vehicle [The speed is the speed?What exactly is this trying to say?]. In addition to the vehicle speed, the output shaft rotation speed N_{OUT}, the rotation speed of the axles 72, the rotation speed of the propeller shaft, or the rotation speed of the output shaft of the differential gear unit 70, for example, may also be used as this vehicle speed related value. Hereinafter in this example embodiment, the value indicative of the vehicle speed will also indicate the vehicle speed related value unless otherwise specified.

The electronic control apparatus 80 outputs various control signals to control the engine output. Some of these signals include a drive signal output to a throttle actuator 28 that operates the throttle valve opening amount TAP of the electronic throttle valve 30; an injection signal for controlling the fuel injection quantity F_{EFI} injected from a fuel injection valve 52; an ignition signal for controlling the ignition timing of the engine 12 by an igniter 54; and a valve command signal for controlling the energizing and de-energizing of a shift linear solenoid valve in the hydraulic pressure control circuit 22 for switching speeds in the automatic transmission 16.

The accelerator pedal 44 is a pedal that is depressed to a degree corresponding to the amount of output required by the driver. In this example embodiment, the accelerator pedal 44 corresponds to an output operating member, and the accelerator depression amount PAP corresponds to the output required.

The hydraulic pressure control circuit 22 mainly includes, for example, a linear solenoid valve SLT that controls the line hydraulic pressure, in addition to the solenoid valve for shift control. The hydraulic pressure in the hydraulic pressure control circuit 22, for example, may also be used to lubricate various parts of the automatic transmission 16 and the like. A manual valve is also provided in the hydraulic pressure control circuit 22. The manual valve is connected via a cable or link or the like to the shift lever 40, for example. Shifting of the shift lever 40 mechanically operates the manual valve so that it switches the hydraulic pressure circuit in the hydraulic pressure control circuit 22.

A shift operation portion 38, which is one example of a shift operation portion that serves as a shift range selecting portion provided with the shift lever 40, is arranged on the center console on the side near the driver's seat, for example. Also, the shift lever 40 is shifted in accordance with shift operating positions P_{SH} provided in the shift operating portion 38. The shift operating positions P_{SH} may include, for example, park “P (parking)”, reverse “R (reverse)”, neutral “N (neutral)”, forward “D (drive)” (the highest speed range position), fifth “5”, fourth “4”, third “3”, second “2”, and first “L”. Park “P”corresponds to a P range, which both renders the automatic transmission 16 in a neutral state in which the power transmitting path in the automatic transmission 16 is interrupted, and locks the output shaft 18 of the automatic transmission 16. Reverse “R” corresponds to an R range for running in reverse. Neutral “N” corresponds to an N range for rendering the automatic transmission 16 in a neutral state in which the power transmitting path in the automatic transmission 16 is interrupted. Forward “D” corresponds to a D range in which the automatic transmission 16 automatically shifts in an automatic shifting mode within a range from first gear speed to sixth gear speed. Fifth “5” corresponds to a 5th range in which the automatic transmission 16 is automatically shifted in a range from first gear speed to fifth gear speed and the engine brake is applied in each gear speed. Fourth “4” corresponds to a 4th range in which the automatic transmission 16 is automatically shifted in a range from first gear speed to fourth gear speed and the engine brake is applied in each gear speed. Third “3” corresponds to a 3rd range in which the automatic transmission 16 is automatically shifted in a range from first gear speed to third gear speed and the engine brake is applied in each gear speed. Second “2” corresponds to a 2nd range in which the automatic transmission 16 is automatically shifted in a range from first gear speed to second gear speed and the engine brake is applied in each gear speed. First “L” corresponds to an L range in which the automatic transmission 16 runs in first gear speed and the engine brake is applied.

The ENG_ECU 82 includes a powertrain manager (PTM) 92 and a driver model (P-DRM) 90 and sets a target driving force value to be produced by the vehicle based on the amount of output required of the vehicle from the VDM_ECU 86 and the DSS_ECU 88, and the signal that indicates the accelerator depression amount PAP. The ENG_ECU 82 then controls the output of the engine 12 to realize that target driving force related value.

The ECT_ECU 84 controls the shifting of the automatic transmission 16 by making shift determinations of the automatic transmission 16 based on the running state of the vehicle, e.g., based on the vehicle speed V and a control amount for controlling the output of the engine 12 by the ENG_ECU 82, such as the throttle valve opening amount TAP. In this example embodiment, the vehicle driving force F is controlled by setting the target driving force related value of the vehicle based on the accelerator depression amount PAP and the vehicle speed, and then executing output control of the engine 12 and/or shift control of the automatic transmission 16 to achieve that target driving force related value.

Here, the driving force related value is a related value (corresponding value) that corresponds one to one with the vehicle driving force (hereinafter simply referred to as “driving force”) F [N] that acts on the surface where the driving wheels 74 contact the ground. The driving force related value may of course be an actually measured value or an estimated (calculated) value of that driving force F, or may also be, for example, the rate of acceleration G [G, m/s₂], the torque of the axles 72 as drive shaft torque (hereinafter referred to as “axle torque”) T_{D} [Nm], vehicle output (hereinafter referred to as “output” or “power”) P [PS, kW, HP], torque of the crankshaft as output torque of the engine 12 (hereinafter referred to as “engine torque”) T_{E} [Nm], torque of the turbine shaft of the torque converter 14 as output torque of the torque converter 14 (hereinafter referred to as “turbine torque”) T_{T} [Nm], i.e., torque of the input shaft as input torque of the automatic transmission 16 (hereinafter referred to as “input shaft torque”) T_{IN} [Nm], torque of the output shaft 18 as output torque of the automatic transmission 16 (hereinafter referred to as “output shaft torque”) T_{OUT} [Nm], and torque T_{P} [Nm] of the propeller shaft, and the like. Hereinafter in this example embodiment, the value indicative of the driving force will also indicate the driving force related value unless otherwise specified.

The VDM_ECU 86 and the DSS_ECU 88 output a required driving force F_{DIM} as the amount of output required for the vehicle in order to automatically control the vehicle-to-vehicle distance, vehicle speed, and dynamic posture of the vehicle, regardless of the accelerator depression amount PAP. For example, the VDM_ECU 86 functionally includes, as vehicle behavior stability control systems (vehicle dynamics management systems), a so-called VSC system which stabilizes vehicle posture during a turn irrespective of the accelerator depression amount PAP, a traction control system that stabilizes vehicle posture when taking off from a standstill, and an ABS control system and the like. This VSC system both outputs the required driving force F_{DIMV} that suppresses the driving force F as well as controls the braking force of the wheels, for example, in order to ensure vehicle posture stability by generating a rear wheel side slip suppressing moment or a front wheel side slip suppressing moment, based on the degree of so-called oversteer tendency in which the rear wheels tend to slip sideways when the vehicle is turning, or so-called understeer tendency in which the front wheels tend to slip sideways when the vehicle is turning.

For example, the DSS_ECU 88 functionally includes, as a driving support control system (DSS: Driver Support System), an automatic vehicle speed control system, i.e., a so-called auto-cruise control system, that automatically controls the driving force to maintain a set distance between vehicles as well as to maintain a set vehicle speed V irrespective of the accelerator depression amount PAP. This auto-cruise control system both outputs the required driving force F_{DIMS} as well as controls the braking force of the wheels to achieve a target vehicle speed V* set by the driver or achieve a target vehicle-to-vehicle distance set by the driver.

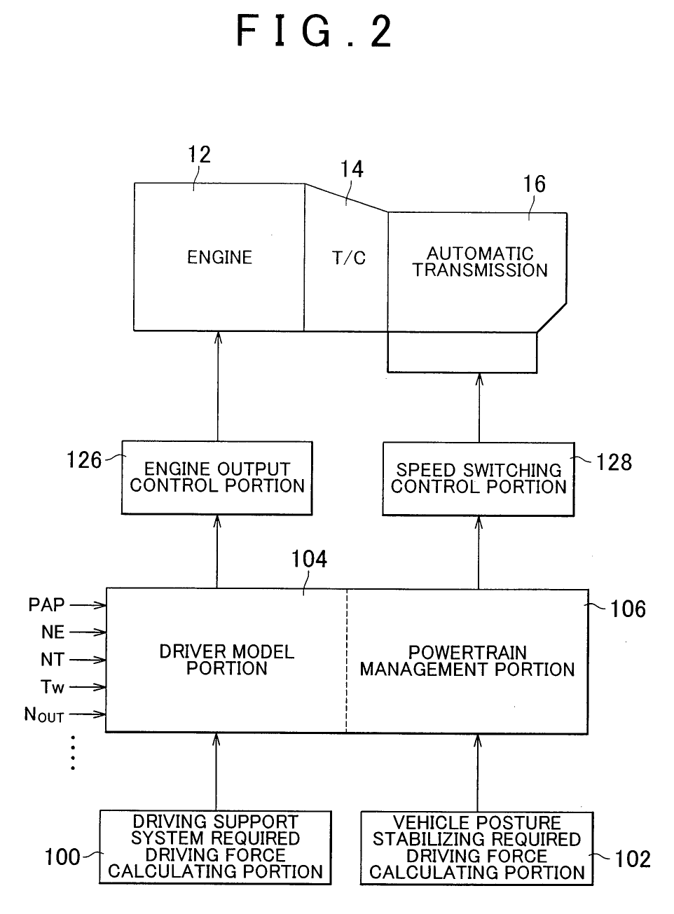

FIG. 2 is a functional block line diagram schematically showing the flow of setting a target driving force F*, calculating a target throttle valve opening amount TAP* for controlling the output of the engine 12, and making a shift determination for the automatic transmission 16 by the electronic control apparatus 80.

A driving support system required driving force calculating portion 100 corresponding to the DSS_ECU 88 outputs the required driving force F_{DIMS} to achieve the target vehicle speed V* set by the driver or the target vehicle-to-vehicle distance set by the driver. A vehicle posture stabilizing required driving force calculating portion 102 corresponding to the VDM_ECU 86 both outputs the required driving force F_{DIMV} that suppresses the driving force F and controls the braking force of the wheels, for example, in order to ensure vehicle posture stability in the longitudinal and lateral directions when turning, braking, and taking off from a standstill.

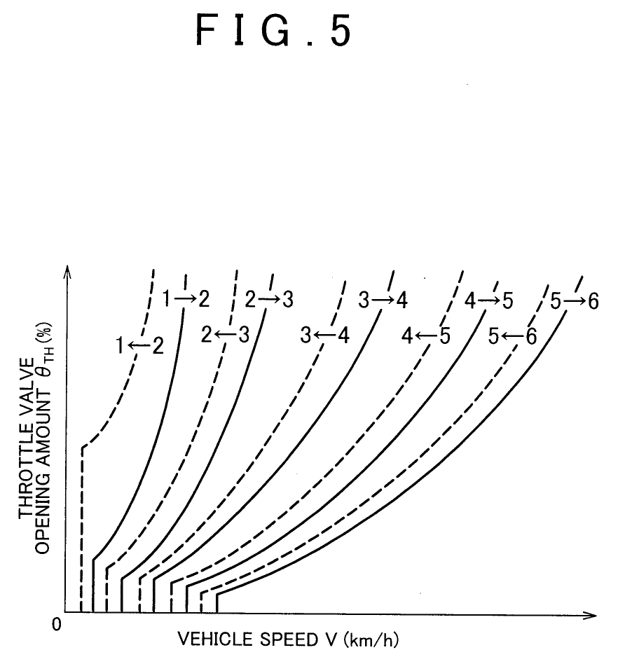

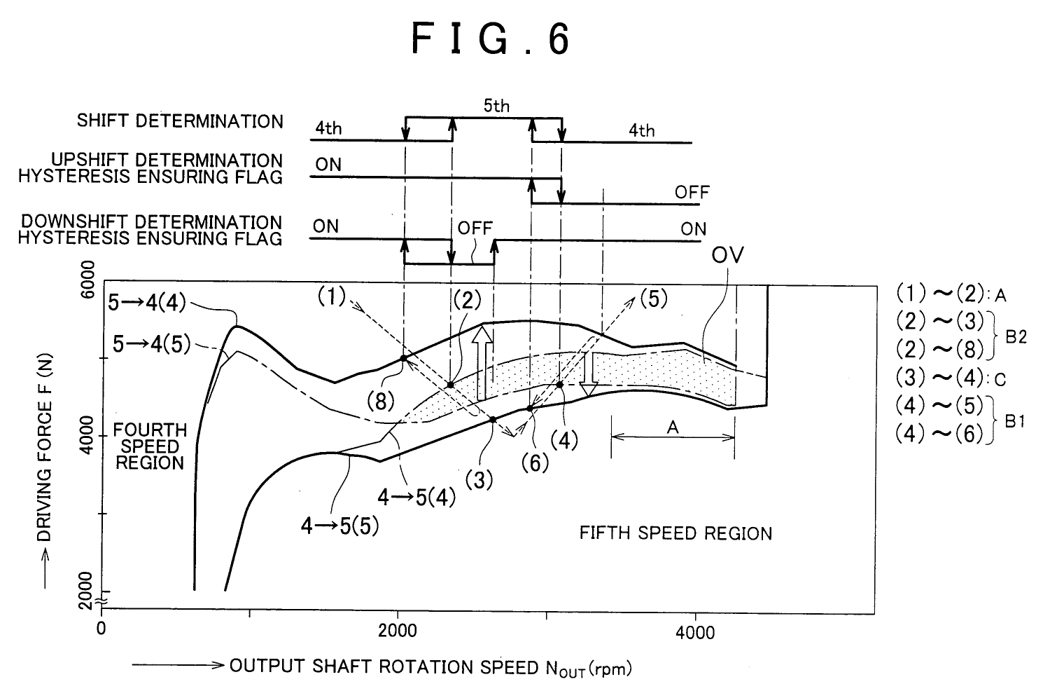

A driver model (DRM) portion 104 also functions as a power transmitting system required output calculating portion that controls the power transmitting apparatus including the automatic transmission 16. The driver model portion 104 calculates the required driving force F_{DIM} based on the accelerator depression amount PAP from a pre-stored relationship in order to output a command to realize the driving force required by the driver. Also, using a shift point opening amount TAP1 for an upshift or a downshift determined based on the vehicle speed V from a pre-stored shift map such as that shown in FIG. 5, for example, the driver model portion 104 calculates a shift point driving force F1 for an upshift or a downshift for use in a pre-stored shift map such as that shown in FIG. 6, for example. The shift lines in FIG. 5 are a series of these shift point opening amounts TAP1, and the shift lines in FIG. 6 are a series of these shift point driving forces F1. The shift lines in FIG. 6 are shown represented by an upshift line for predetermined speeds, e.g., fourth speed to fifth speed, and a downshift line for predetermined speeds, e.g., fifth speed to fourth speed.

A powertrain management (PTM) portion 106 makes a shift determination based on the command from the driver model portion 104 and outputs a shift command signal to the automatic transmission 16, as well as outputs an output torque command signal for obtaining a target engine torque TE* to the engine 12. That is, the powertrain management portion 106 calculates an engine torque control required driving force F_{T} and a shift determination required driving force F_{S} in which the required driving force F_{DIMS} from the driving support system required driving force calculating portion 100 and the required driving force F_{DIMV} from the vehicle posture stabilizing required driving force calculating portion 102 have been added to the required driving force F_{DIM}. Normally, the shift determination required driving force F_{S} and the engine torque control required driving force F_{T} are basically the same value, but they may also be slightly different values depending on the tuning. Also, the powertrain management portion 106 converts that engine torque control required driving force F_{T}(=target driving force F*) into the target engine torque TE* and instructs the engine 12 to output that target engine torque TE*. Also, if the required driving force F_{DIMS} from the driving support system required driving force calculating portion 100 and the required driving force F_{DIMV} from the vehicle posture stabilizing required driving force calculating portion 102 are not output, the powertrain management portion 106 compares the actual throttle opening amount TAP with the shift point opening amount TAP1 determined based on the vehicle speed V from the pre-stored shift map shown in FIG. 5. If the actual throttle opening amount TAP is greater than the shift point opening amount TAP1, the powertrain management portion 106 makes a determination to downshift. If, on the other hand, the actual throttle opening amount TAP is less than the shift point opening amount TAP1, the powertrain management portion 106 makes a determination to upshift. The powertrain management portion 106 then outputs a command to the automatic transmission 16 so that the determined speed is established. However, if the required driving force F_{DIMS} from the driving support system required driving force calculating portion 100 or the required driving force F_{DMIV} from the vehicle posture stabilizing required driving force calculating portion 102 is output, the powertrain management portion 106 compares the actual shift determination required driving force F_{S} with the shift point driving force F1 determined based on the output shaft rotation speed N_{OUT} from the shift map shown in FIG. 6. If the actual shift determination required driving force F_{S} is greater than the shift point driving force F1, the powertrain management portion 106 makes a determination to downshift. If, on the other hand, the actual shift determination required driving force F_{S} is less than the shift point driving force F1, the powertrain management portion 106 makes a determination to upshift. The powertrain management portion 106 then outputs a command to the automatic transmission 16 so that the determined speed is established.

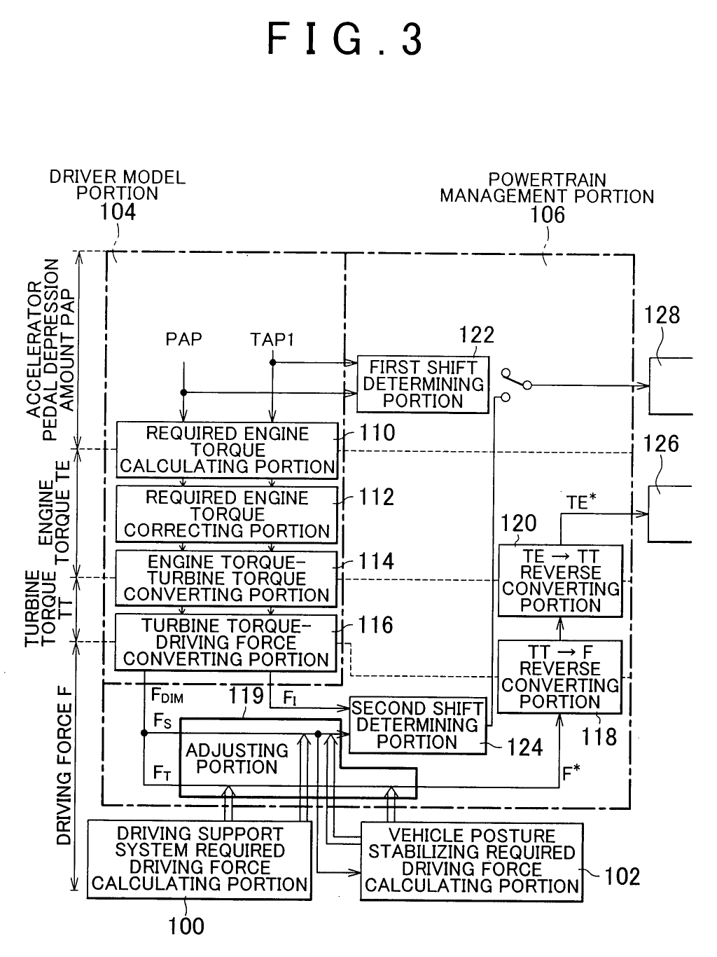

FIG. 3 is a detailed view of the structure of the driver model portion 104 and the powertrain management portion 106. As shown in the drawing, the driver model portion 104 includes a required engine torque calculating portion 110, a required engine torque correcting portion 112, an engine torque-turbine torque converting portion 114, and a turbine torque-driving force converting portion 116. Also, the powertrain management portion 106 includes an adjusting portion 119, a torque-driving force reverse converting portion 118, an engine torque-turbine torque reverse converting portion 120, a first shift determining portion 122, and a second shift determining portion 124.

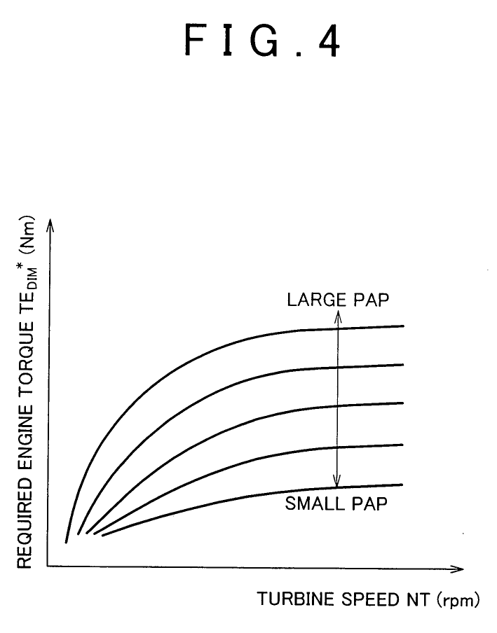

In FIG. 3, the required engine torque calculating portion 110 calculates a required engine torque TE_{DIM} based on the actual accelerator depression amount PAP and the turbine speed NT from a relationship (i.e., map) for realizing the driving force required by the driver shown in FIG. 4, which is stored beforehand, for example. The required engine torque correcting portion 112 corrects the required engine torque TE_{DIM} to obtain the desired output torque based on the engine coolant temperature T_{W}, the intake air temperature T_{A}, and the atmospheric pressure P_{A} from a pre-stored relationship. In this correction, the required engine torque TE_{DIM} is corrected to output torque between the minimum torque and the maximum torque so that the minimum torque able to be output by the engine 12 is output when the accelerator depression amount PAP is 0% and the maximum torque able to be output by the engine 12 is output when the accelerator depression amount PAP is 100%. Therefore, the torque rises quickly when the accelerator pedal 44 is depressed even slightly.

The engine torque-turbine torque converting portion 114 calculates an actual speed ratio e (=NT/NE) of the torque converter 14, as well as calculates an actual torque ratio t (=TT/TE) based on that speed ratio e from a pre-stored relationship. The engine torque-turbine torque converting portion 114 then converts the engine torque to the required turbine torque TT_{DIM} by multiplying that torque ratio t by the corrected required engine torque TE_{DIM}. The turbine torque-driving force converting portion 116 functions as a required driving force setting portion which calculates the required driving force F_{DIM} of the vehicle, which is the driving force at the point of contact between the driving wheels 74 and the ground, by multiplying the speed ratio γ of the gear speed (after the shift) of the automatic transmission 16 determined by the shift determination, the gear ratio of the differential unit, and the transfer efficiency by the required turbine torque TT_{DIM} and adding the inertia torque. In this way, because the speed ratio γ of the gear speed determined by the shift determination of the first shift determining portion 122 and the second shift determining portion 124 is used when converting the required turbine torque TT_{DIM} to the required driving force F_{DIM}, the required driving force F_{DIM} increases or decreases by the amount of change in the speed ratio γ so the driving force of the vehicle can be continuously maintained even during shifting. Incidentally, conventionally the engine is instructed to output the required engine torque as it is. Also, the shift determination was made using that required engine torque or the shift determination was made after converting that required engine torque to the accelerator depression amount using a reverse lookup map. Therefore, the engine torque is output according to the required engine torque but the shift point was determined by the accelerator depression amount corresponding to that required engine torque, which resulted in the realized driving force of the vehicle being discontinuous.

The adjusting portion 119 reflects other required driving forces, such as the required driving force F_{DIMS} from the driving support system required driving force calculating portion 100 and the required driving force F_{DIMV} from the vehicle posture stabilizing required driving force calculating portion 102, in the required driving force F and supplies the resultant driving force to the second shift determining portion 124 and the torque-driving force reverse converting portion 118. For example, when another required driving force F_{DIMS} or F_{DIMV} is generated, it is replaced by the required driving force F which is output and supplied to the second shift determining portion 124 and the torque-driving force reverse converting portion. 118 as the shift determination required driving force F_{S} and the engine torque control target driving force F_{T}. This engine torque control target driving force F_{T} corresponds to the target driving force F* so the adjusting portion 119 also functions as a target driving force setting portion. The torque-driving force reverse converting portion 118 converts the engine torque control target driving force F_{T} to the required turbine torque TT_{DIM} by an operation that is opposite that performed by the turbine torque-driving force converting portion 116. The engine torque-turbine torque reverse converting portion 120 converts that required turbine torque TT_{DIM} to the target engine torque TE* by an operation that is opposite that performed by the engine torque-turbine torque converting portion 114 and outputs the result to an engine output control portion 126. The engine output control portion 126 controls the output torque of the engine 12 by adjusting the throttle valve opening amount TAP and the like to obtain the target engine torque TE*.

If the required driving force F_{DIMS} from the driving support system required driving force calculating portion 100 and the required driving force F_{DIMV} from the vehicle posture stabilizing required driving force calculating portion 102 are not output, the first shift determining portion 122 compares the actual throttle opening amount TAP with the shift point opening amount TAP1 determined based on the vehicle speed V from the pre-stored shift map shown in FIG. 5. If the actual throttle opening amount TAP is greater than the shift point opening amount TAP1, the first shift determining portion 122 makes a determination to downshift. If, on the other hand, the actual throttle opening amount TAP is less than the shift point opening amount TAP1, the first shift determining portion 122 makes a determination to upshift. The first shift determining portion 122 then outputs a command to the speed switching control portion 128 so that the speed of the automatic transmission 16 is changed to the determined speed. The speed switching control portion 128 switches gear speeds by operating the friction engagement devices needed to establish the determined speed.

If the required driving force F_{DIMS} from the driving support system required driving force calculating portion 100 and/or the required driving force F_{DIMV} from the vehicle posture stabilizing required driving force calculating portion 102 is/are output, the second shift determining portion 124 compares the actual shift determination required driving force F_{S} with the shift point driving force F1 determined based on the output shaft rotation speed N_{OUT} from the shift map shown in FIG. 6. If the actual shift determination required driving force F_{S} is greater than the shift point driving force F1, the second shift determining portion 124 makes a determination to downshift. If, on the other hand, the actual shift determination required driving force F_{S} is less than the shift point driving force F1, the second shift determining portion 124 makes a determination to upshift. The second shift determining portion 124 then outputs a command to the speed switching control portion 128 so that the determined speed is established. The speed switching control portion 128 switches gear speeds by operating the friction engagement devices needed to establish the determined speed.

The shift map shown in FIG. 6 used by the second shift determining portion 124 to make the shift determination includes upshift lines and downshift lines set for each speed in an orthogonal two-dimensional coordinate system having a driving force axis (the vertical axis) which has the driving force F generated in each speed of the automatic transmission 16 as a parameter, and a vehicle speed axis (the horizontal axis) which has the output shaft rotation speed N_{OUT} related to the vehicle speed V as a parameter. In FIG. 6, a 5→4 downshift line and a 4→5 upshift line with hysteresis between the two are given as examples. The 5→4 (5) downshift line shown by the alternate long and short dash line is the 5→4 downshift line based on the speed ratio γ₅ of the fifth gear speed before the downshift. The 5→4 (4) downshift line shown by the solid line is a 5→4 downshift line based on the speed ratio γ₄ of the fourth gear speed after the downshift. Also, the 4→5 (4) upshift line shown by the alternate long and short dash line is a 4→5 upshift line based on the speed ratio γ₄ of the fourth gear speed before the upshift. The 4→5 (5) upshift line shown by the solid line is a 4→5 upshift line based on the speed ratio γ₅ of the fifth gear speed after the upshift. For example, the 5→4 downshift line based on the speed ratio γ₅ of the fifth gear speed before the downshift is a series of shift point driving forces calculated from the speed ratio γ₅ of the fifth gear speed.

The shift lines in the shift map in FIG. 6 are shift lines in which the vertical axes of the shift lines in FIG. 5 have been converted into driving force of the predetermined gear speed, for example. The engine 12, which is an internal combustion engine, has an output characteristic in which the output torque TE initially rises relatively rapidly as the actual throttle opening amount TAP increases but then reaches its maximum at a certain point. Therefore, the 5→4 (5) downshift line shown by the alternate long and short dash line and the 4→5 (4) upshift line shown by the alternate long and short dash line, which are both a series of shift point driving forces that were converted with the speed ratio of the predetermined gear speed, become closer together and overlap each other, thus forming an overlap region OV in which the fifth speed region and the fourth speed region overlap. Therefore, when the actual driving force reaches the edge of the threshold value shown by the shift line when the running conditions are such that the required driving force does not change much, such as when running at a constant speed on a road on level ground or on a gradient, shift hunting tends to occur in which the automatic transmission 16 repeatedly upshifts and downshifts with the slightest fluctuation in required driving force. In this example embodiment, when this kind of required driving force only fluctuates minutely and is otherwise relatively stable, in the region where a slight oscillation may result in an upshift, it is possible to prevent a frequent upshifting by eliminating the overlap region OV by switching from the 4→5 (4) upshift line to the 4→5 (5) upshift line based on the speed ratio γ₅ after the shift, thus shifting the 4→5 upshift line down (to the low driving force side). Also, in the region where a slight oscillation may result in a downshift, it is possible to prevent frequent downshifting by eliminating the overlap region OV by switching from the 5→4 (5) downshift line to the 5→4 (4) downshift line based on the speed ratio γ₄ after the shift, thus shifting the 5→4 downshift line up (to the high driving force side).

Also, related to eliminating the overlap region OV, an area A is formed in which the lowered 4→5 (5) upshift line and the 5→4 (5) downshift line almost match up and the raised 5→4 (4) downshift line and the 4→5 (4) upshift line almost match up, i.e., the upshift lines and downshift lines derived from the same speed ratio γ almost match up, in the region where the output torque TE of the engine 12 reaches its maximum with respect to the throttle opening amount TAP. In this kind of area A as well, shift hunting tends to occur when the required driving force is within that area A. In this example embodiment, this shift hunting is prevented by temporarily prohibiting an upshift immediately after a downshift for a certain period of time (referred to here as “prohibited time”) determined based on the distance from the downshift line.

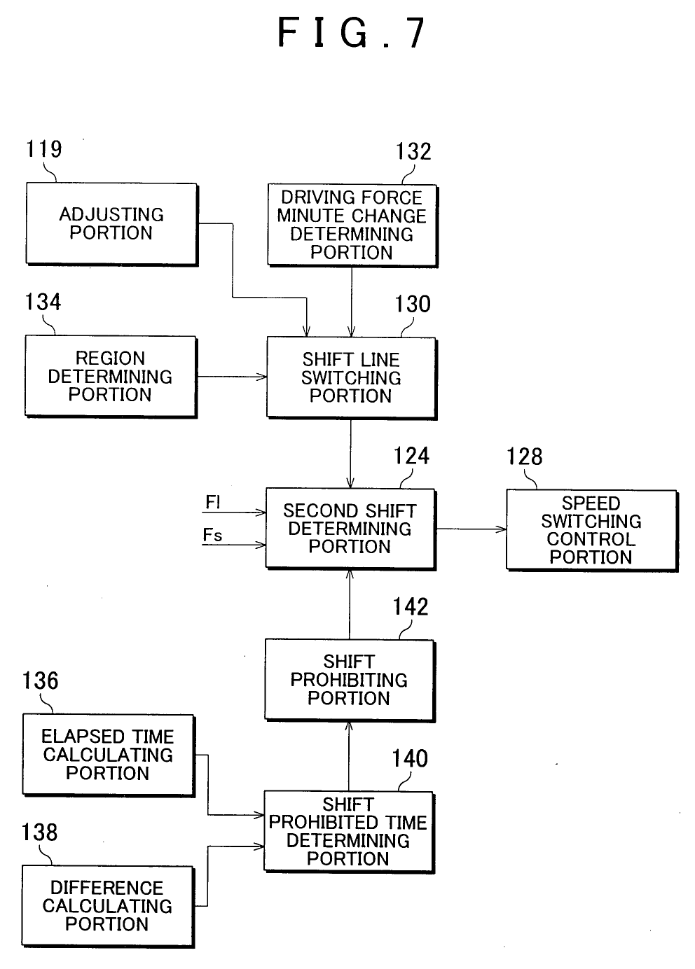

FIG. 7 is an even more detailed view of a function realizing portion which, although not shown in FIG. 3, is provided in connection with the second shift determining portion 124. In FIG. 7, in order to determine whether to perform one shift, from among a downshift and an upshift from a predetermined gear speed after the other shift from among a downshift and an upshift from was performed, a shift line switching portion 130 switches from the shift line based on the speed ratio of the predetermined gear speed to a shift line based on a speed ratio after the one shift, and the second shift determining portion 124 makes the shift determination using that switched shift line in order to prevent shift hunting when making the shift determination using the shift map in FIG. 6. For example, the shift line switching portion 130 switches from the 4→5 (4) upshift line based on the speed ratio γ₄ of the current speed to the 4→5 (5) upshift line based on the speed ratio γ₅ after the shift in order to determine whether to perform a 4→5 upshift after a 5→4 downshift, and switches from the 5→4 (5) downshift line based on the speed ratio γ₅ of the current speed to the 5→4 (4) downshift line based on the speed ratio γ₄ after the shift in order to determine whether to perform a 5→4 downshift after a 4→5 upshift. Accordingly, when a determination is made to shift into a speed adjacent to the speed before the shift according to the shift line determined by the speed ratio of the speed before the shift and the same shift determination is reached according to the shift line determined by the speed ratio of the adjacent speed, the shift into that adjacent speed is permitted (allowed) so the shift line switching portion 130 also functions as a shift allowing portion.

A driving force minute change determining portion 132 determines whether the driving force of the vehicle is minutely changing within a predetermined range set in advance. This predetermined range is determined by upper and lower limit values of a ratio or value set to determine a stable state. For example, it is determined whether a moving average value of the driving force of the vehicle is within this range. This driving force of the vehicle is not limited to only the actual driving force as long as it is a parameter related to the driving force such as the target driving force F*, the actual engine torque TE, the target engine torque TE*, or the accelerator depression amount PAP. When the driving force minute change determining portion 132 determines that the driving force of the vehicle is minutely changing, the shift line switching portion 130 switches from a shift line [4→5 (4) upshift line or 5→4 (5) downshift line] based on the speed ratio of the current speed to a shift line [4→5 (5) upshift line or 5→4 (4) downshift line] based on the speed ratio after the shift.

A region determining portion 134 determines whether a point representing the vehicle state indicated by the driving force of the vehicle, i.e., the driving force and the vehicle speed (output shaft rotation speed N_{OUT}), is within a region that crosses the shift line that was switched by the shift line switching portion 130, i.e., the shift line based on the speed ratio after the shift, in the shift map shown in FIG. 6. For example, the region determining portion 134 determines whether that point is within a region that crosses the 4→5 (5) upshift line or the 5→4 (4) downshift line. If the region determining portion 134 determines that the driving force of the vehicle is within the region that crosses the shift line based on the speed ratio after the shift, the shift line switching portion 130 returns the switched shift line to its original position. For example, if a switch is made from the 4→5 (4) upshift line to the 4→5 (5) upshift line based on the speed ratio γ₅ after the shift in order to determine whether to perform a 4→5 upshift after a 5→4 downshift, the shift line switching portion 130 returns that 4<5 (5) upshift line to the original 4→5 (4) upshift line. Similarly, if a switch is made from the 5→4 (5) downshift line to the 5→4 (4) downshift line based on the speed ratio γ₄ after the shift in order to determine whether to perform a 5→4 downshift after a 4→5 upshift, the shift line switching portion 130 returns that 5→4 (4) downshift line to the original 5→4 (5) downshift line.

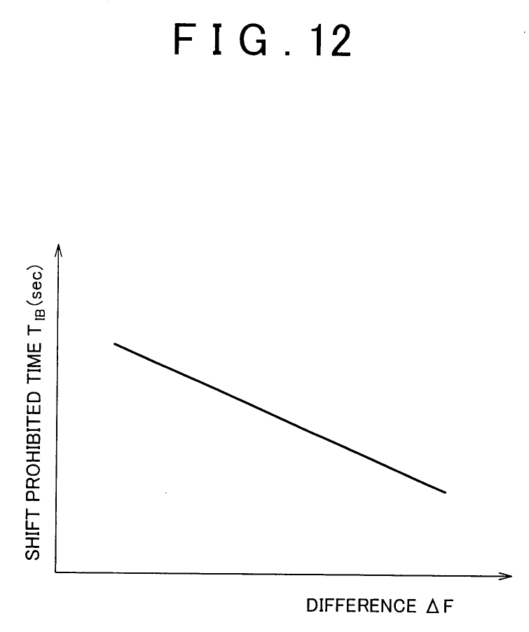

An elapsed time calculating portion 136 counts the elapsed time t_{EL} from the time a shift (either a downshift or a upshift) was executed, e.g., the elapsed time from the start of the shift or the end of the shift. A difference calculating portion 138 sequentially calculates the distance, i.e., difference ΔF, between the driving force of the vehicle and the shift line used to determine that shift. A shift prohibited time determining portion 140 sequentially determines a shift prohibited time T_{IB} based on the actual difference ΔF calculated by the difference calculating portion 138, from a pre-stored relationship in which the shift prohibited time T_{IB} decreases as the difference ΔF increases, as shown in FIG. 12 for example. A shift prohibiting portion 142 prohibits execution of another shift or shift determination (i.e., for a downshift if the previous shift was an upshift or an upshift if the previous shift was a downshift) until the elapsed time t_{EL} after the shift was executed exceeds the shift prohibited time T_{IB}.

When the adjusting portion 119 adjusts the required driving force F_{DIMS} output from the driving support system required driving force calculating portion 100 and/or the required driving force F_{DIMV} output from the vehicle posture stabilizing required driving force calculating portion 102 with respect to the required driving force F_{DIM} output from the power transmitting system required output calculating portion 104, in order to determine whether to perform one shift, from among a downshift and an upshift from the predetermined gear speed after the other shift from among a downshift and an upshift was performed, the shift line switching portion 130 switches the shift line from the shift line based on the speed ratio of the predetermined gear speed to the shift line based on the speed ratio after the one shift. For example, in order to determine whether to perform a 4→5 upshift after a 5→4 downshift, the shift line switching portion 130 switches the shift line from the 4→5 (4) upshift line based on the speed ratio γ₄ of the current speed to the 4→5 (5) upshift line based on the speed ratio γ₅ after the shift. Similarly, in order to determine whether to perform a 5→4 downshift after a 4→5 upshift, the shift line switching portion 130 switches the shift line from the 5→4 (5) downshift line based on the speed ratio γ₅ of the current speed to the 5→4 (4) downshift line based on the speed ratio γ₄ after the shift.

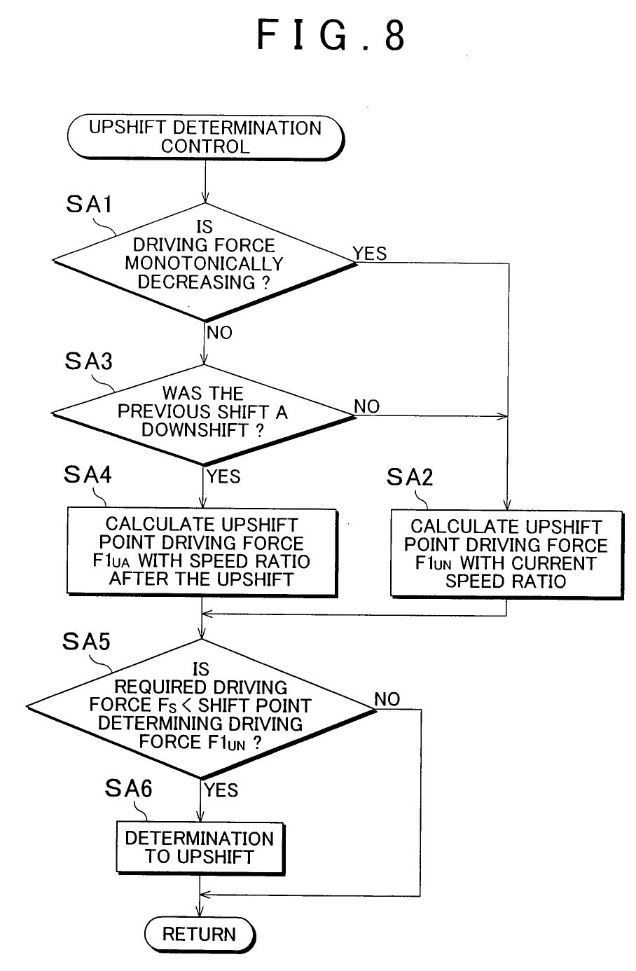

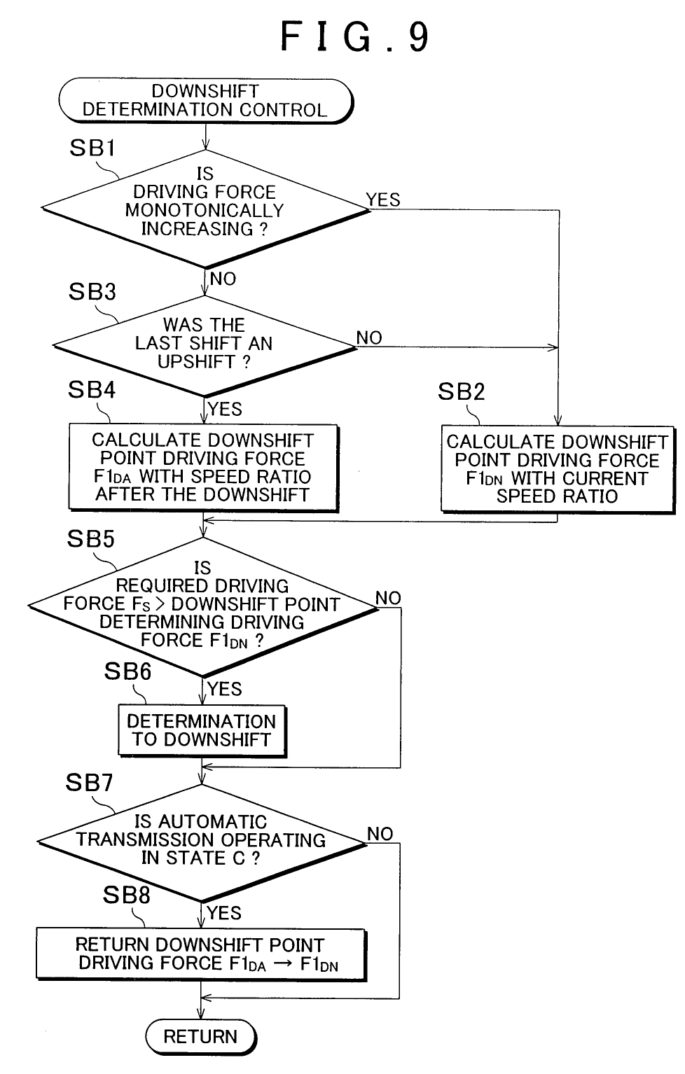

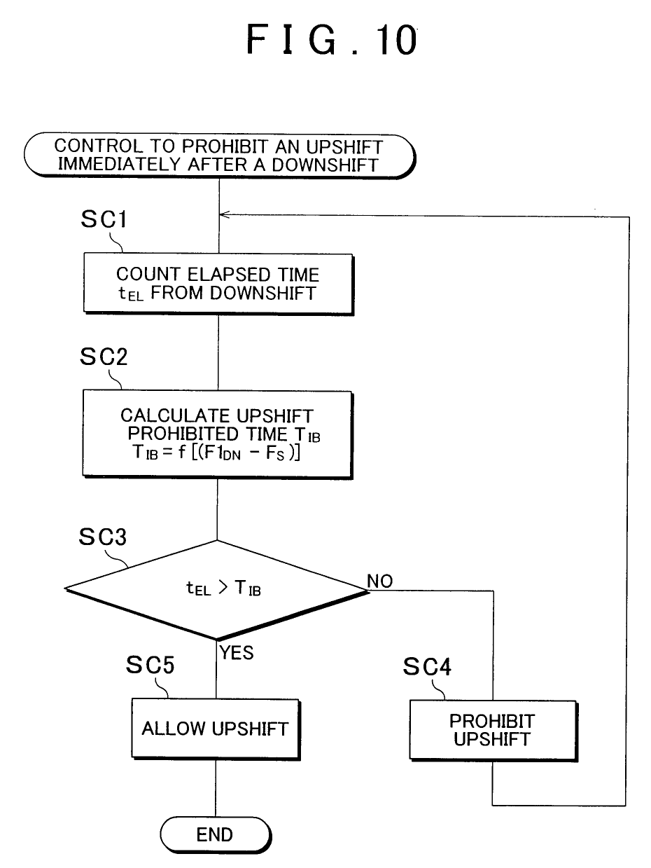

FIGS. 8, 9, and 10 are flowcharts illustrating the main portions of control operations of the electronic control apparatus 80 that are executed on the condition that the required driving force F_{DIMS} from the driving support system required driving force calculating portion 100 and/or the required driving force F_{DIMV} from the vehicle posture stabilizing required driving force calculating portion 102 is/are being output. FIG. 8 shows a control routine for determining an upshift, FIG. 9 shows a control routine for determining a downshift, and FIG. 10 shows a control routine for prohibiting an upshift immediately after a downshift. These control routines are repeatedly executed in cycles of several milliseconds to several tens of milliseconds, for example.

In FIG. 8, in step SA1 corresponding to the driving force minute change determining portion 132, it is determined whether the driving force of the vehicle is stable and changing minutely within a predetermined range that was set in advance, or whether the driving force of the vehicle is not stable but rather basically decreasing monotonically in one direction so that it falls outside of that predetermined change region. If it is determined in step SA1 that the driving force of the vehicle is monotonically decreasing, i.e., if it is determined that the driving force of the vehicle is not minutely changing, an upshift point driving force F1_{UN} based on the current speed ratio is calculated in step SA2. That is, when running in the fourth gear speed, for example, a value that corresponds to the output shaft rotation speed N_{OUT} at that time in the 4→5 (4) upshift line based on the speed ratio γ₄ of the fourth gear speed which is the current speed in the shift map shown in FIG. 6 is used as the normal upshift point driving force F1_{UN}.

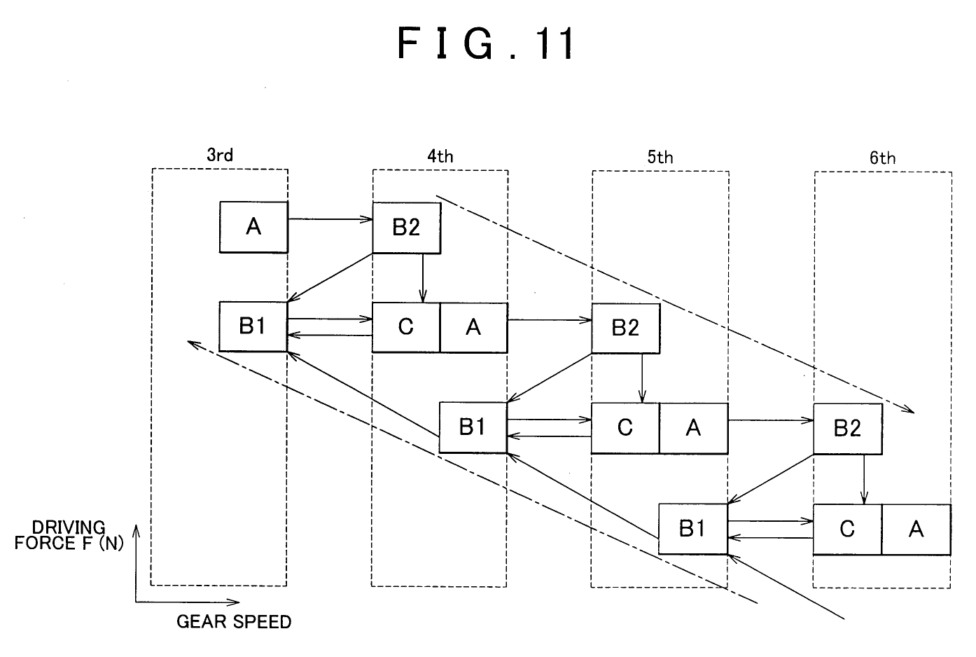

Next in step SA5, it is determined whether the shift determination required driving force F_{S} is less than the upshift point driving force F1_{UN}. If the determination in step SA5 is no, this cycle of the routine ends. If, on the other hand, the determination is yes, then a determination to upshift is made in step SA6. Accordingly, the operating state of the automatic transmission 16 switches from state A to state B2 in FIG. 11. In this example embodiment, steps SA5 and SA6 correspond to the second shift determining portion 124.

If the driving force of the vehicle is stable and minutely changing within the predetermined range set in advance, the determination in step SA1 is no so it is next determined in step SA3 whether the last shift was a downshift. If the determination in step SA3 is no, steps SA2 and thereafter are executed. If, on the other hand, the determination in step SA3 is yes, the automatic transmission 16 is operating in state B1 in FIG. 11 and an upshift point driving force F1_{UA} based on the speed ratio of the predetermined gear speed after the upshift is calculated in step SA4 which corresponds to shift line switching portion 130. That is, when the vehicle is running in the fourth gear speed, for example, a value that corresponds to the output shaft rotation speed N_{OUT} at that time in the 4→5 (4) upshift line based on the speed ratio γ₅ of the fifth gear speed which is the current speed in the shift map shown in FIG. 6 is used as the normal upshift point driving force F1_{UA}. Therefore, in step SA4, essentially, a switch is made from the 4→5 (4) upshift line based on the speed ratio γ₄ of the fourth gear speed which is the current speed to the 4→5 (5) upshift line based on the speed ratio γ₅ of the fifth gear speed after the shift in order to use it in the upshift determination. Then steps SA5 and SA6 are executed in the same manner as described above. As a result, the operating state of the automatic transmission 16 changes from state B1 to state C in FIG. 11.

In FIG. 9, in step SB1 which corresponds to the driving force minute change determining portion 132, it is determined whether the driving force of the vehicle is stable and minutely changing in the predetermined range that was set in advance, or whether the driving force of the vehicle is not stable but rather basically monotonically increasing in one direction so as to fall outside of that predetermined change range. If it is determined in step SB1 that the driving force of the vehicle is monotonically increasing, i.e., if it is determined that the driving force of the vehicle is not minutely changing, then a downshift point driving force F1_{DN} based on the current speed ratio is calculated in step SB2. That is, if the vehicle is running in the fifth gear speed, for example, a value that corresponds to the output shaft rotation speed N_{OUT} at that time in the 5→4 (5) downshift line based on the speed ratio γ₅ of the fifth gear speed which is the current speed in the shift map shown in FIG. 6 is used as the normal downshift point driving force F1_{DN}.

Next in step SB5 it is determined whether the shift determination required driving force F_{S} is greater than the downshift point driving force F1_{DN}. If the determination in step SB5 is no, this cycle of the routine ends. If, on the other hand, the determination is yes, then a determination to downshift is made in step SB6. Accordingly, the operating state of the automatic transmission 16 switches from state B1 or state C to state B1 in FIG. 11. In this example embodiment, steps SB5 and SB6 correspond to the second shift determining portion 124.

If the driving force of the vehicle is stable and minutely changing within the predetermined range set in advance, the determination in step SB1 is no so it is next determined in step SB3 whether the last shift was an upshift. If the determination in step SB3 is no, steps SB2 and thereafter are executed. If, on the other hand, the determination in step SB3 is yes, a downshift point driving force F1_{DA} based on the speed ratio of the predetermined gear speed after the downshift is calculated in step SB4 which corresponds to shift line switching portion 130. That is, when the vehicle is running in the fifth gear speed, for example, a value that corresponds to the output shaft rotation speed N_{OUT} at that time in the 5→4 (4) downshift line based on the speed ratio γ₄ of the fourth gear speed in the shift map shown in FIG. 6 is used as the normal downshift point driving force F1_{DA}. Therefore, in step SB4, essentially, a switch is made from the 5→4 (5) downshift line based on the speed ratio y5 of the fifth gear speed which is the current speed to the 5→4 (4) downshift line based on the speed ratio γ₄ of the fourth gear speed after the shift in order to use it in the downshift determination. Then steps SB5 and SB6 are executed in the same manner as described above. As a result, the operating state of the automatic transmission 16 changes from state B2 to state B1 in FIG. 11.

In step SB7 which corresponds to the region determining portion 134, it is determined whether a point representing the driving force of the vehicle is within a region that crosses a shift line that is based on the speed ratio after the shift, e.g. the 5→4 (4) downshift line that is based on the speed ratio γ₄ of the fourth gear speed after the shift. That is, it is determined whether the automatic transmission 16 is operating in state C in FIG. 11. If the determination in step SB7 is no, this cycle of the routine ends. If, on the other hand, the determination is yes, the downshift point driving force returns from F1_{DA} to F1_{DN} in step SB8. That is, the shift line is returned from the 5→4 (4) downshift line that is based on the speed ratio γ₄ of the fourth gear speed to 5→4 (5) that is based on the speed ratio γ₅ of the fifth gear speed, which is provided for the next shift determination.

When explained in terms of the broken lines that represent the driving force in FIG. 6 when that driving force is monotonically decreasing and monotonically increasing, the area from point (1) to point (2) corresponds to state A in FIG. 11, the area from point (2) to point (3) and the area from point (2) to point (8) correspond to state B2 in FIG. 11, the area from point (3) to point (4) corresponds to state C in FIG. 11, the area from point (4) to point (5) and the area from point (4) to point (6) corresponds to state B1 in FIG. 11.

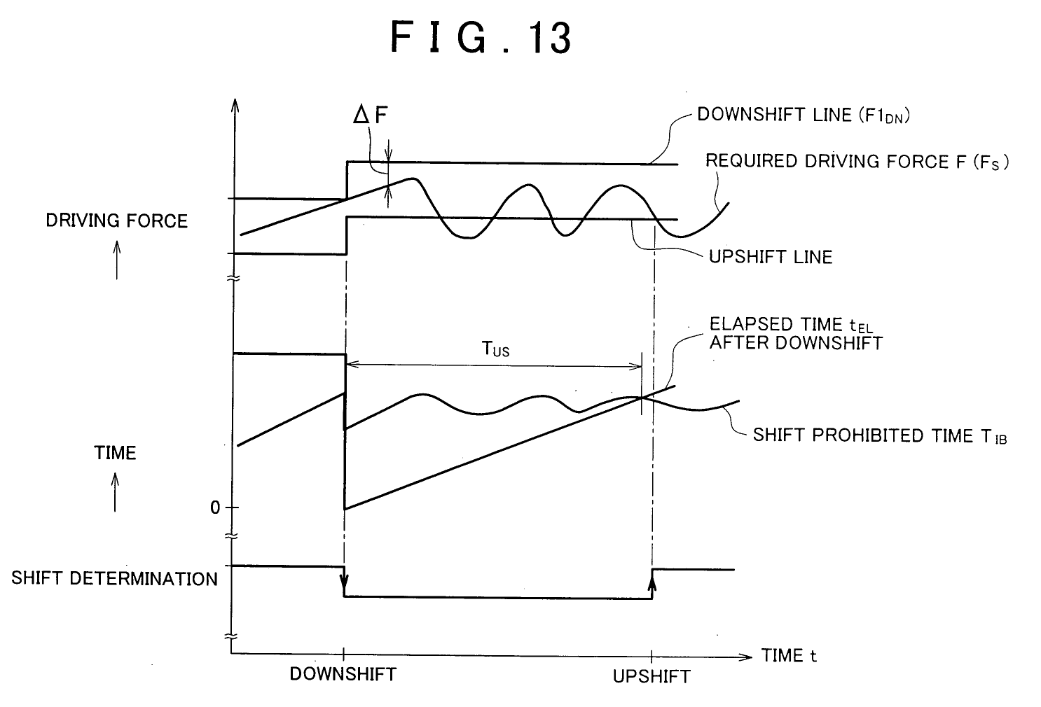

In FIG. 10, in step SC1 which corresponds to the elapsed time calculating portion 136, the elapsed time t_{EL} from the downshift is counted. Next in step SC2 which corresponds to the difference calculating portion 138 and the shift prohibited time determining portion 140, first the distance, i.e., the difference ΔF [=f(F1_{DN}−F_{S})], between the driving force of the vehicle and the downshift line used to determine a downshift is sequentially calculated, as shown in FIG. 13. The reason the downshift line and upshift line increase in a stepped fashion at the time of the downshift in FIG. 13 is because the speed ratio increases in a stepped fashion from the downshift. Next, the shift prohibited time T_{IB} is sequentially determined based on the actual difference ΔF from a pre-stored relationship in which the shift prohibited time T_{IB} becomes shorter as the difference ΔF increases, as shown in FIG. 12, for example.

In step SC3 it is determined whether the elapsed time t_{EL} has exceeded the shift prohibited time T_{IB}. Initially the determination in step SC3 is no so an upshift is prohibited in step SC4. However, if the determination is yes, an upshift is allowed. In this example embodiment steps SC3 to SC5 correspond to the shift prohibiting portion 142.

As described above, according to this example embodiment, when making a determination to perform one shift (either a downshift or an upshift) from a predetermined gear speed after the other shift (an upshift if the one shift was a downshift or a downshift if the one shift was an upshift) was performed, the shift line switching portion 130 switches the shift line from the shift line based on the speed ratio of the predetermined gear speed to a shift line based on the speed ratio after the one shift. Therefore, the second shift determining portion 124 determines the one shift using the shift line based on the speed ratio after the one shift and then executes that shift. Therefore, in the shift map in FIG. 6, the region OV in which the upshift line of a predetermined gear speed and the downshift line of a speed adjacent to, on the higher speed side of, that speed overlap is eliminated so shift hunting is able to be prevented.

Also according to this example embodiment, when the driving force minute change determining portion 132 determines that the driving force of the vehicle is minutely changing, the shift line switching portion 130 switches the shift line from the shift line based on the speed ratio of the predetermined gear speed to the shift line based on the speed ratio after the one shift. Therefore, when the driving force of the vehicle is minutely changing in the predetermined range, such as when cruise control is operating, the shift line switching portion 130 can switch the shift line from the shift line based on the speed ratio of a predetermined gear speed to a shift line based on the speed ratio after the one shift. As a result, shift hunting which tends to occur when the driving force is minutely changing can be prevented.

Also according to this example embodiment, the region determining portion 134 is provided which determines whether the driving force of the vehicle is within a region that crosses a shift line based on the speed ratio after the one shift, which was switched by the shift line switching portion 130. When that region determining portion 134 has determined that the driving force of the vehicle is within the region that crosses the shift line based on the speed ratio after the one shift, the shift line switching portion 130 returns the shift line from the shift line based on the speed ratio after that one shift to the shift line based on the speed ratio of the predetermined gear speed. Accordingly, the shift line is returned to its original position when the driving force of the vehicle is in a region in which shift hunting will not occur even without ensuring hysteresis, so the driving force of the vehicle can be ensured.

Further, this example embodiment includes the elapsed time calculating portion 136 that counts the elapsed time t_{EL} from the time a downshift is performed, the difference calculating portion 138 that calculates the difference ΔF between the driving force of the vehicle and the shift line used in determining a downshift, the shift prohibited time determining portion 140 that determines the shift prohibited time T_{IB} based on the difference calculated by the difference calculating portion 138 from the pre-stored relationship shown in FIG. 12, and the shift prohibiting portion 142 that prohibits an upshift until the elapsed time t_{EL} exceeds the shift prohibited time T_{IB}. Therefore, in particular, in the vehicle high speed region, shift hunting due to a slight fluctuation in driving force can be prevented in the region in which the downshift line into a predetermined gear speed based on the speed ratio of that predetermined gear speed and the upshift line from that predetermined gear speed become close together so that hysteresis is extremely small, as well as in the region in which the downshift line into a speed adjacent to the predetermined gear speed, which is based on the speed ratio of that adjacent speed, and the upshift line from that adjacent speed become close together so that hysteresis is extremely small.

Also according to this example embodiment, when driving force is required from the driving support control system (cruise control) or vehicle behavior stability control system as control systems which automatically control the driving force of the vehicle irrespective of the amount of output required by the driver, i.e., when the required driving force F_{DIMS} from the driving support system required driving force calculating portion 100 is output and/or the required driving force F_{DIMV} from the vehicle posture stabilizing required driving force calculating portion 102 is output, the shift line is switched from the shift line that is based on the speed ratio of a predetermined gear speed to a shift line that is based on the speed ratio after the one shift. Therefore, the shift control is executed based on the shift line that was switched based on the required driving force that is required by the control system that automatically controls the driving force of the vehicle such as cruise control. As a result, when the driving force of the vehicle is minutely changing within a predetermined range, such as when cruise control is operating, the shift line switching portion 130 switches the shift line from the shift line based on the speed ratio of the predetermined gear speed to the shift line based on the speed ratio after the one shift. Thus, shift hunting which tends to occur when the driving force minutely changes is prevented.

Although example embodiments of the invention have been described with reference to the drawings, the invention is not limited to the described embodiments or constructions.

For example, the target driving force and required driving force used in the foregoing example embodiment may also be related values that correspond on a one to one thereto. For example, the target torque, required driving force, or the intake air amount, fuel injection quantity, accelerator depression amount PAP, or throttle opening amount TAT that reflect the target torque and the required driving force may also be used as the related value.

Also in the foregoing example embodiment, a control is performed that prohibits an upshift until the elapsed time t_{EL} after a preceding downshift is performed exceeds the shift prohibited time T_{IB}. Alternatively, however, control may also be, performed that prohibits a downshift until the elapsed time t_{EL} after a preceding upshift is performed exceeds the shift prohibited time T_{IB}. Further in the foregoing example embodiment, a VSC system, an ABS control system, and a traction control system are given as examples of vehicle posture stability control systems and the invention is applied when those systems are operating. However, the invention can be applied as long as control to stabilize the posture of the vehicle, even if that control is control other than the control by these systems. For example, the invention can also be applied when control is performed by a TRC (Traction Control) system that ensures driving force F that corresponds to the state of the road surface and thus ensures take-off acceleration performance, the ability of the vehicle to drive straight, and turning stability by controlling the driving force F and the braking force to inhibit the driving wheels 74 from slipping during situations such as in which, during take-off or acceleration on a slippery road, for example, the throttle is opened too wide such that excessive torque is generated which causes the driving wheels 74 slip, thereby reducing the ability to take-off or accelerate, as well as controllability.

Further, in the foregoing example embodiment, the accelerator pedal 44 is given as an example of the output operating member. However, the output operating member is not limited to this as long as it reflects a requirement by the driver with respect to a driving force related value. For example, the output operating member may also be a lever switch or a rotary switch or the like that is operated by hand. Alternatively, an operating member may be omitted and the requirement of the driver with respect to the driving force related value may be reflected by voice input.

While the invention has been described with reference to example embodiments thereof, it is to be understood that the invention is not limited to the described embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the spirit and scope of the invention.

What is claimed is:

1. A driving force control apparatus for a vehicle having an engine and a stepped automatic transmission that is operatively linked to the engine, comprising:
a target driving force setting portion that sets a target driving force of the vehicle;
a shift determining portion that determines a speed into which the stepped automatic transmission is to be shifted based on at least vehicle driving force from a pre-stored shift map having hysteresis between an upshift line and a downshift line of a predetermined gear speed of the stepped automatic transmission; and
a shift line switching portion which, in order to determine whether to perform one shift, from among a downshift and an upshift to an adjacent gear speed from the predetermined gear speed after the other shift from among a downshift and an upshift was performed, switches a shift line from a shift line that is based on a speed ratio of the predetermined gear speed to a shift line that is based on the speed ratio after the one shift.

2. The driving force control apparatus according to claim 1, further comprising:
a driving force minute change determining portion that determines whether the driving force of the vehicle is minutely changing within a predetermined range,
wherein when the driving force minute change determining portion determines that the driving force of the vehicle is minutely changing, the shift line switching portion switches the shift line from the shift line that is based on the speed ratio of the predetermined gear speed to the shift line that is based on the speed ratio after the one shift.

3. The driving force control apparatus according to claim 1, further comprising;
a region determining portion that determines whether the driving force of the vehicle is within a region that crosses the shift line that is based on the speed ratio after the one shift and to which the shift line was switched by the shift line switching portion,
wherein when the region determining portion determines that the driving force of the vehicle is within the region that crosses the shift line that is based on the speed ratio after the one shift, the shift line switching portion returns the shift line from the shift line that is based on the speed ratio after the one shift to the shift line that is based on the speed ratio of the predetermined gear speed.

4. The driving force control apparatus according to claim 1, further comprising:
an elapsed time calculating portion that counts the elapsed time after the other shift, from among the downshift and the upshift, was performed;
a difference calculating portion that calculates a difference between the driving force of the vehicle and the shift line used to determine the other shift;
a shift prohibited time determining portion that determines a shift prohibited time during which a shift is prohibited, based on the difference calculated by the difference calculating portion from a pre-stored relationship; and
a shift prohibiting portion that prohibits the one shift, from among the downshift and the upshift, from being performed until the elapsed time exceeds the shift prohibited time.

5. The driving force control apparatus according to claim 1, wherein the shift map includes an upshift line and a downshift line set for each speed in a two-dimensional coordinate system having a driving force axis which has driving force generated in each speed of the automatic transmission as a parameter, and a vehicle speed axis which has the speed of the vehicle as a parameter.

6. The driving force control apparatus according to claim 1, further comprising:
a control system that automatically controls the driving force of the vehicle irrespective of an amount of output required by a driver,
wherein the target driving force setting portion sets the target driving force of the vehicle by adjusting a required driving force that is required by the control system, and when driving force is required by the control system, the shift line switching portion switches the shift line from the shift line that is based on the speed ratio of the predetermined gear speed to the shift line that is based on the speed ratio after the one shift.

7. A driving force control method for a vehicle having an engine and a stepped automatic transmission that is operatively linked to the engine, comprising:
a) setting a target driving force of the vehicle;
b) determining a speed into which the stepped automatic transmission is to be shifted based on at least vehicle driving force from a pre-stored shift map having hysteresis between an upshift line and a downshift line of a predetermined gear speed of the stepped automatic transmission; and
c) switching, in order to determine whether to perform one shift, from among a downshift and an upshift to an adjacent gear speed from a predetermined gear speed after the other shift from among a downshift and an upshift was performed, a shift line from a shift line that is based on a speed ratio of the predetermined gear speed to a shift line that is based on the speed ratio after the one shift.

8. The driving force control method according to claim 7, further comprising:
d) determining whether the driving force of the vehicle is minutely changing within a predetermined range,
wherein when it is determined by step d) that the driving force of the vehicle is minutely changing, step c) switches the shift line from the shift line that is based on the speed ratio of the predetermined gear speed to the shift line that is based on the speed ratio after the one shift.

9. The driving force control method according to claim 7, further comprising;
e) determining whether the driving force of the vehicle is within a region that crosses the shift line that is based on the speed ratio after the one shift and to which the shift line was switched by step c),
wherein when it is determined by step e) that the driving force of the vehicle is within the region that crosses the shift line that is based on the speed ratio after the one shift, step
c) returns the shift line from the shift line that is based on the speed ratio after the one shift to the shift line that is based on the speed ratio of the predetermined gear speed.

10. The driving force control method according to claim 7, further comprising:
f) counting the elapsed time after the other shift, from among the downshift and the upshift, was performed;
g) calculating a difference between the driving force of the vehicle and the shift line used to determine the other shift;
h) determining a shift prohibited time during which a shift is prohibited, based on the difference calculated by step g) from a pre-stored relationship; and
i) prohibiting the one shift, from among the downshift and the upshift, from being performed until the elapsed time exceeds the shift prohibited time.

11. The driving force control method according to claim 7, wherein the shift map includes an upshift line and a downshift line set for each speed in a two-dimensional coordinate system having a driving force axis which has driving force generated in each speed of the automatic transmission as a parameter, and a vehicle speed axis which has the speed of the vehicle as a parameter.

12. The driving force control method according to claim 7, further comprising:
j) automatically controlling the driving force of the vehicle irrespective of an amount of output required by a driver,
wherein step a) sets the target driving force of the vehicle by adjusting a required driving force that is required by step j), and when driving force is required by step j), step c) switches the shift line from the shift line that is based on the speed ratio of the predetermined gear speed to the shift line that is based on the speed ratio after the one shift.
